(19) United States
(12) Patent Application Publication
(10) Pub. No.: US 2009/0220361 A1
(43) Pub. Date: Sep. 3, 2009

(54) COOLING OF STATOR FOR COMPRESSOR

(75) Inventor: Bjorn Lind, Goteborg (SE)

Correspondence Address: SCHWEGMAN, LUNDBERG & WOESSNER, P.A., P.O. BOX 2938, MINNEAPOLIS, MN, 55402, US

(73) Assignee: lIND fINANCE & Development AB, Goteborg (SE)

(21) Appl. No.: 12/066,931

(22) PCT Filed: Sep. 13, 2006
(86) PCT No.: PCT/SE2006/050326

§ 371 Date: Sep. 12, 2008

(30) Foreign Application Priority Data
Sep. 15, 2005 (SE) 0502033-4

(51) Int. Cl. F04D 25/06; F16J 15/16; F03B 13/00; H02K 9/04

(52) U.S. Cl. 417/423.7; 277/300; 290/54; 310/62

(57) ABSTRACT

Arrangement for cooling a compressor comprising a housing (Ia, Ib) with an inlet (13) and an outlet (14) and enclosing in its volume (12) a stator including stator winding (2) and stator iron (3) of an electric motor, which drives a rotor (9) with a shaft (6). The invention is characterized in that the volume (12) is arranged separated from the rotating parts (9, 6) in a sealed manner.

The present invention relates to a design for cooling an electric motor in a compressor according to the precharacterizing clause of Patent claim 1.

Technology within the field of fuel cells generating electrical energy as an alternative to fossil fuels, as a primary energy source for vehicles for example, is aiming at more compact and more efficient units. The principle of fuel cells can be described very generally as hydrogen gas and oxygen reacting with one another via electrodes, generating electrical energy. The “exhaust gas product” in the reaction between hydrogen and oxygen is water. The oxygen required in the process is supplied in the form of great quantities of air at positive pressure.

The present invention relates to cooling of an electric motor in a compressor for producing the process air required, where the compressor is supplied with energy via on the one hand an electric motor and on the other hand recovery of at least part of the energy remaining in the process air after it has passed through the fuel cells. The requirements for the unit are low weight and small volume, which is achieved in part by using an efficient and low-volume cooling method. This has been achieved by the invention having been provided with the features indicated in Patent claim 1.

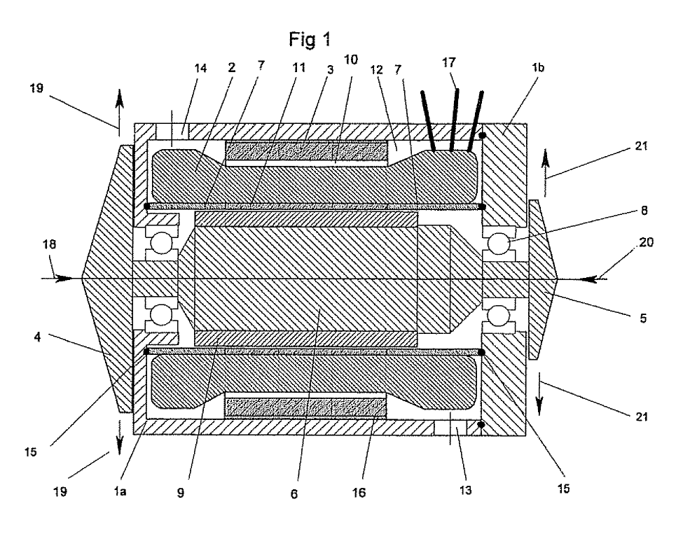

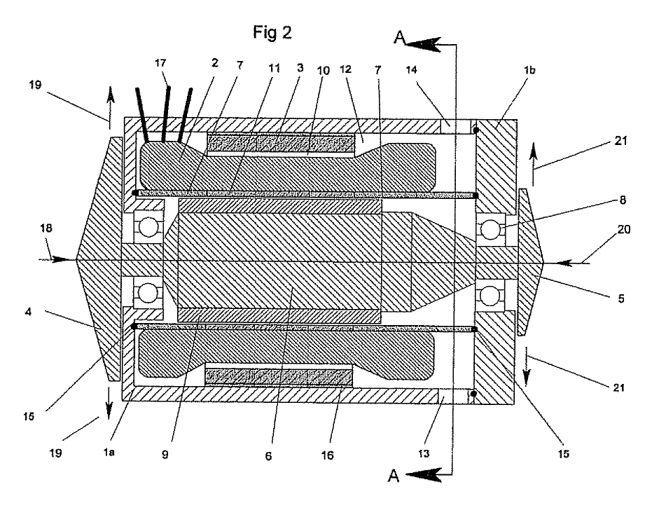

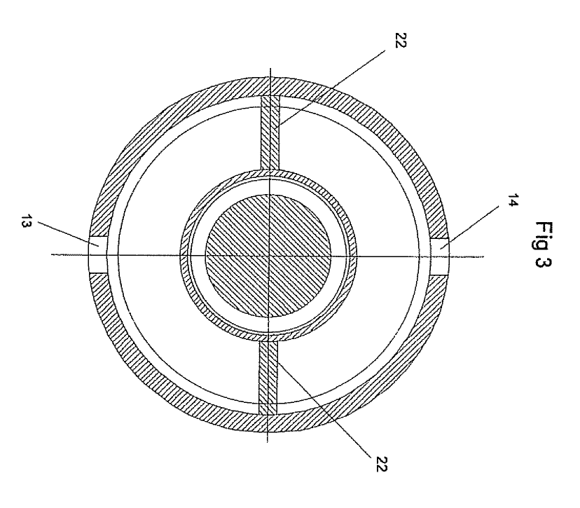

The invention will be described in greater detail in the form of examples with reference to the drawing, in which FIG. 1 shows an embodiment of the invention, FIG. 2 shows another embodiment of the invention and FIG. 3 shows a section along the line A-A in FIG. 2.

In FIG. 1 and FIG. 2, 1a and 1b designate an essentially cylindrical housing, which has centrally the stator 3 of an electric motor connected to the housing 1a, and an impeller 4 and a turbine wheel 5 which are interconnected by means of a common shaft 6. The common shaft 6, bearing the impeller 4 and the turbine wheel 5, can be mounted relative to the compressor housing by any bearing method, for example fluid bearings, magnetic bearings, ball bearings or roller bearings.

In the drawing, 9 designates the rotor of an electric motor, which rotor is fastened to the shaft 6. The stator winding 2 of the electric motor is, together with its stator iron 3, received in a space 12 in the housing 1a, 1b. The parts 2, 3 of the electric motor, sleeves 7 and the housing 1a, 1b are cooled by a coolant which is introduced through an inlet 13, flows through the stator winding 2 and the stator iron 3 via channels 10 (winding slots) and leaves the space 12 through an outlet 14. The space 12 is sealed completely in relation to the rotating parts, the rotor 9, the shaft 6, with the aid of the cylindrical sealing sleeves 7 arranged between the stator winding 2 and the rotor 9 with the shaft 6, which on the one hand seal in relation to the stator iron, the winding slots 10 of which are sealed 11 in the region between the stator winding and the rotor, and on the other hand are sealed by O rings for example in relation to the housing parts 1a and 1b. The design of the cooling system as described contributes considerably to the compact design of the compressor. 17 indicates diagrammatically electric cables and other connections to the stator of the motor.

In FIG. 3, 22 designates barriers which are arranged axially in the space 12 and bring about reduced direct communication between the volumes at the inlet 13 and the outlet 14 on the right side of the stator in the figure, which form inlet and outlet volumes in order to allow the bulk of the coolant to pass via the inlet 13 through the stator to its left side and back through the stator to the outlet 14. Seen in FIG. 2, the barriers 22 extend from the inside of the right housing end wall to the right delimitation of the stator iron 3, which thus separates the inlet 13 from the outlet 14 in fluid terms. The purpose of this design is that the coolant can be connected to the unit on only one side of the stator (the right side in FIG. 2).

The compressor and turbine housings with inlets, guide vanes and outlets are not illustrated in the drawing, but it is understood that these function in a known manner. The arrow 18 thus indicates process air which is drawn in and fed out (indicated by arrow 19) at positive pressure to the fuel cell. In order to increase efficiency, residual process air is dealt with (indicated by arrows 20 and 21) by the turbine wheel 5, which recovers energy, which is returned to the impeller 4 in order, together with the energy supplied via the electric motor, to drive the impeller 4.

As mentioned, the space 12 is flowed through by a coolant (inlet 13, outlet 14) which cools the stator iron, the stator winding and the compressor housing 1a, 1b. In order to make cooling of the stator winding and the stator iron possible, these must be insulated against direct contact with the coolant as the coolant can be electrically conductive or corrosive. This can suitably be effected by means of a thin, heat-conducting protective film made of a material which is not electrically conductive and is not affected by the coolant. In order to make it possible to machine a close tolerance on the outside diameter of the stator without the stator iron being exposed, a machinable material 16, which tolerates the coolant, has been applied firmly to the outside diameter of the stator iron before the protective film is applied, whereupon the outside diameter of the stator can be machined exactly.

In order to make it possible to machine a close tolerance on the outside diameter of the stator without the stator iron being exposed, a machinable material which tolerates the coolant has been applied firmly to the outside diameter of the stator iron before the protective film is applied, and the outside diameter of the stator can then be machined exactly.

1. An arrangement for cooling a compressor comprising a housing with an inlet and an outlet and enclosing in its volume a stator including stator winding and stator iron of an electric motor, which drives a rotor with a shaft, characterized in that the volume is arranged separated from the rotating parts in a sealed manner.

2. The arrangement for cooling a compressor according to claim 1, wherein a cooling fluid, is arranged to pass around and/or through the parts of the stator, which have been sealed, at least in the regions where the parts of the stator are exposed to contact with the cooling fluid, with a heat-conducting surface coating resistant to the cooling fluid made of a material which is not electrically conductive.

3. The arrangement for cooling a compressor according to claim 2, wherein the volume of the housing contains barriers for guiding the flow path of the cooling fluid in the housing from the inlet to the outlet of the housing.

4. The arrangement for cooling a compressor according to claim 3, wherein a turbine wheel can be coupled to the essentially electric-motor-driven impeller for returning energy recovered from the residual process air.

5. A method for sealing the rotors comprising applying a machinable material resistant to the coolant to the outside diameter of the stator, applying a sealing protective film made of a material resistant to the coolant to the stator iron and the stator winding, and machining the machinable material of the stator iron to the desired diameter.

6. The arrangement for cooling a compressor according to claim 1, wherein the volume of the housing includes internal barriers to guide the flow path of the cooling fluid in the housing from the inlet to the outlet of the housing.

7. The arrangement for cooling a compressor according to claim 6, wherein a turbine wheel is couplable to the essentially electric-motor-driven impeller for returning energy recovered from the residual process air.

8. The arrangement for cooling a compressor according to claim 7, wherein the cooling fluid includes a gas.

9. The arrangement for cooling a compressor according to claim 1, wherein the cooling fluid includes a liquid.

10. The arrangement for cooling a compressor according to claim 2, wherein the cooling fluid includes a liquid.
